(19) United States
(12) Patent Application Publication
(10) Pub. No.: US 2010/0066600 A1
(43) Pub. Date: Mar. 18, 2010

(54) MOBILE APPARATUS FOR TRACKING SATELLITE AND METHOD THEREOF

(75) Inventors: Jeom Hun Lee, Daejeon (KR); Sang Uk Lee, Daejeon (KR); In One Joo, Daejeon (KR); Tae Hee Kim, Daejeon (KR); Jae Hoon Kim, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/447,812

(22) PCT Filed: Oct. 31, 2007
(86) PCT No.: PCT/KR07/05480

§ 371 Date: Apr. 29, 2009

(30) Foreign Application Priority Data
Nov. 16, 2006 (KR) 10-2006-0113236

(51) Int. Cl. G01S 19/24

(52) U.S. Cl. 342/357.02; 342/357.07

(57) ABSTRACT

A mobile apparatus for tracking a satellite, includes: a mobile unit; a GPS receiving unit mounted on the mobile unit that generates position coordinates of the mobile unit; a level meter mounted on the mobile unit that adjusts the mobile unit in horizontal and obtains a tilt angle of the mobile unit; an antenna unit mounted on the mobile unit and being adjusted to the true north direction according to the position coordinates. Further, the mobile apparatus for tracking a satellite includes position tracking control unit mounted on the mobile unit that temporarily stops the mobile unit when tracking a position of the satellite, adjusts the mobile unit in horizontal by the level meter and aligns the position coordinates and the tile angles to correct current position information of the mobile unit.

### TECHNICAL FIELD

The present invention relates to a satellite tracking apparatus and method and, more particularly, to a mobile apparatus for tracking a satellite and method thereof, which is capable of accurately tracking a position of the satellite while moving.

### BACKGROUND ART

In general, a satellite ground control system is able to control a satellite floating in space from ground, and functions to monitor and adjust various states of the satellite; and make plans and issue commands to allow the satellite to duly perform its task. The satellite ground control system tracks a position of the satellite by transmitting a command to the satellite and receiving telemetry data therefrom.

The satellite ground control system of the prior art performs tracking and controlling on the satellite generally in a fixed state on the ground, so if the satellite ground control system is damaged due to an earthquake or a war, it cannot normally perform its task with respect to the satellite until recovery. If the satellite ground control system is not recovered for a long period of time, it can hardly track a position of the satellite.

If the satellite ground control system tracks and controls the satellite while moving, accurate satellite azimuth angle and accurate angle of elevation should be obtained and a satellite tracking apparatus thereof should be accurately aligned.

However, in case that the satellite ground control system is on the move, it is difficult to accurately obtain the satellite azimuth angle and the angle of elevation through the satellite tracking apparatus. Accordingly, there is a limitation in receiving a telemetry signal from the satellite, transmitting a telecommand signal to the satellite from the ground, and accurately tracking satellite position required for controlling the satellite.

### DISCLOSURE OF INVENTION

### Technical Problem

In view of the above, the present invention is to provide a mobile apparatus for tracking a satellite and method thereof capable of precisely tracking satellite position even while moving.

### Technical Solution

In accordance with an aspect of the present invention, there is provided a mobile apparatus for tracking a satellite, including: a mobile unit; a GPS receiving unit mounted on the mobile unit that generates position coordinates of the mobile unit; a level meter mounted on the mobile unit that adjusts the mobile unit in horizontal and obtains a tilt angle of the mobile unit; an antenna unit mounted on the mobile unit and being adjusted to the true north direction according to the position coordinates; and position tracking control unit mounted on the mobile unit that temporarily stops the mobile unit when tracking a position of the satellite, adjusts the mobile unit in horizontal by the level meter and aligns the position coordinates and the tile angles to correct current position information of the mobile unit.

In accordance with another aspect of the present invention, there is provided a method for tracking a satellite by using a mobile apparatus for tracking a satellite, including: fixing the mobile apparatus for tracking a satellite; setting coordinates of current position of the mobile apparatus for tracking a satellite; and measuring an elevation angle and an azimuth angle of the satellite using the mobile apparatus for tracking a satellite, thereby obtaining position information of the satellite.

### Advantageous Effects

In accordance with the present invention, it is possible to track the satellite even while moving and to precisely track the satellite position.

In addition, because the azimuth angle and the elevation angle of the satellite are precisely obtained through the satellite tracking device, the telecommand signal can be accurately transmitted from the ground to the satellite and the telemetry signal can be accurately transmitted from the satellite.

### BRIEF DESCRIPTION OF THE DRAWINGS

The objects and features of the present invention will become apparent from the following description of embodiments given in conjunction with the accompanying drawings, in which:

FIG. 1 is a schematic block diagram of a mobile apparatus for tracking a satellite in accordance with an embodiment of the present invention;

FIG. 2 is a detailed block diagram showing the mobile apparatus for tracking the satellite in accordance with the embodiment of the present invention;

FIG. 3 is a flow chart sequentially illustrating the process of setting coordinates of current position of a mobile apparatus for tracking the satellite in accordance with the embodiment of the present invention; and

FIG. 4 is a flow chart sequentially showing the process of tracking a mobile apparatus for tracking the satellite in accordance with the embodiment of the present invention.

### BEST MODE FOR CARRYING OUT THE INVENTION

Hereinafter, embodiments of the present invention will be described in detail with reference to the accompanying drawings which form a part hereof.

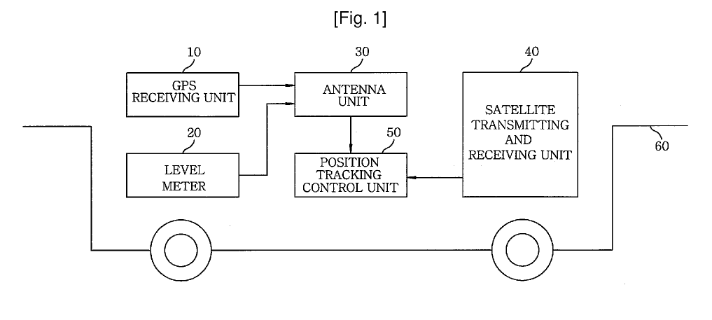

FIG. 1 is a schematic block diagram of a mobile apparatus for tracking a satellite in accordance with an embodiment of the present invention.

As shown in FIG. 1, the mobile apparatus for tracking a satellite of the present invention includes a GPS receiving unit 10, a level meter 20, an antenna unit 30, a satellite transmitting and receiving unit 40, a position tracking control unit 50 and a mobile unit 60 having the above elements mounted thereon.

In order to set coordinates of current position of the mobile unit 60 where the mobile apparatus is mounted, the GPS receiving unit 10 receives position coordinate signals including the latitude, the longitude, and the altitude of the mobile unit 60 from a GPS satellite (not shown), and transfers the signals to the antenna unit 30. In this case, it is possible to search the true north direction serving as a reference of the azimuth angle by connecting points that come in the same longitude with respect to several different latitudes by using the GPS receiving unit 10.

The level meter 20 adjusts a level of the mobile unit 60 in horizontal, obtains a tilt angle for the alignment of the coordinates of the current position, which is the slope of the position tracking control unit 50 in the north-south direction and in the east-west direction, and transfers the obtained tilt angle to the antenna unit 30.

The antenna unit 30 adjusts the true north direction of an antenna 32 based on the position coordinate signals received from the GPS receiving unit 10, and relays the tilt angle transferred from the level meter 20 to the mobile unit 60, to thereby setting the absolute position coordinates of the mobile unit 60.

The satellite transmitting and receiving unit 40 transmits a telecommand signal issued from the position tracking control unit 50 to a satellite (not shown), receives a measurement signal from the satellite, and transfers the measurement signal to the position tracking control unit 50.

In tracking the position of the satellite, the position tracking control unit 50 controls the mobile unit 60 to be fixed in a stop state. This operation is to set coordinates of current position of the position tracking apparatus mounted on the mobile unit 60. In the stop state, the position tracking control unit 50 sets the true north direction of the antenna 32 provided from the antenna unit 30 into the azimuth angle reference direction of the antenna, adjusts the position coordinates of the mobile unit 60 and obtains information on the satellite position of the satellite. After that, the position tracking control unit 50 transmits the telecommand signal to the satellite (not shown) via the satellite transmitting and receiving unit 40 and receives the measurement signal from the satellite.

Therefore, in the mobile apparatus for tracking the satellite of the present invention, after the mobile unit 60 is adjusted in horizontal by using the level meter, the azimuth angle reference direction of the antenna is set as the true north direction, and then the coordinates of current position of the mobile unit 60 are set. Accordingly, the satellite position information can be precisely tracked by adjusting the current coordinates of the mobile unit 60 and signals can be received from the satellite while transmitting the telecommand signal to the position-tracked satellite.

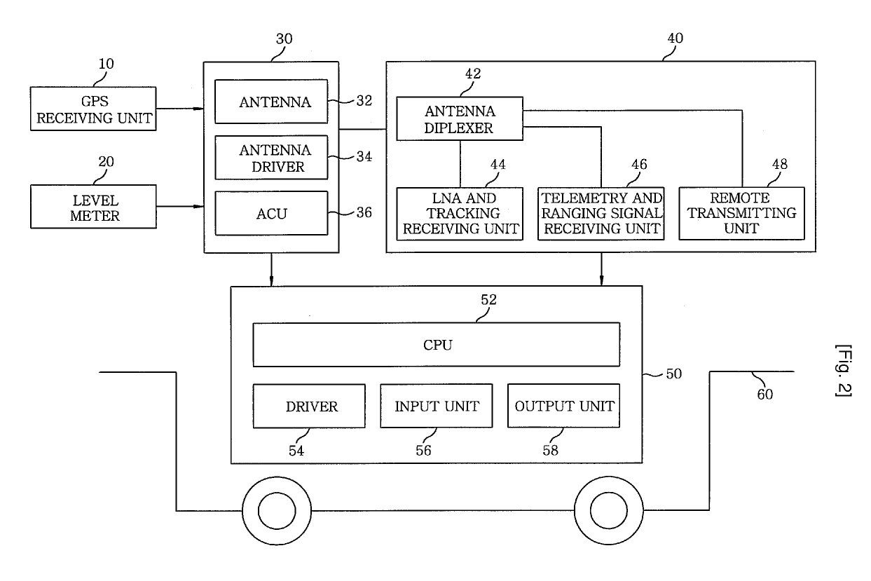

FIG. 2 is a detailed block diagram showing the mobile apparatus for tracking a satellite in accordance with an embodiment of the present invention.

As shown in FIG. 2, the antenna unit 30 includes the antenna 32 that receives a satellite signal including the measurement signal; an antenna driver 34 that adjusts the position of the antenna 32; and an antenna control unit (ACU) 36 that adjusts the true north direction of the antenna 32 upon receiving the position coordinate and the tilt angle signals from the GPS receiving unit 10 and the level meter 20, respectively, and transfers the tilt angle provided the level meter 20 to a CPU 52 of the position tracking control unit 50.

The satellite transmitting and receiving unit 40 includes an antenna diplexer 42 that receives the satellite signal from the satellite while transmitting the telecommand signal to the satellite via the antenna 30; an LNA (Low Noise Amplifier) and tracking receiving unit 44 that amplifies the received satellite signal, tracks it, and transfers it to the position tracking control unit 50; a telemetry and ranging signal receiving unit 46 that receives the measurement signal from the satellite and transfers it to the position tracking control unit 50; and a remote transmitting unit 48 that transmits the telecommand signal from the position tracking control unit 50 to the satellite.

The position tracking control unit 50 includes the CPU 52 which adjust the mobile unit 60 in horizontal at the time of settling initial position coordinates of the mobile unit 60, receives the tilt angle signal in the north-south direction and in the east-west direction to adjust the antenna in the true north direction, thereby setting an absolute position coordinates of the mobile unit 60 in order for absolute alignment of the mobile unit 60 so that it precisely tracks the position of satellite, and controls the satellite transmitting and receiving unit 40 to receive the signal from the satellite while transmitting the telecommand signal to the position-tracked satellite; a driver 54 that controls the mobile unit 60 to be moved or stopped; an input unit 56 that enters a key command for operating the mobile unit 60 and arbitrary command or data for tracking the satellite; and an output unit which may be a display or a speaker 58 that provides the satellite position information and an operational state of the mobile unit 60 visually or auditorily.

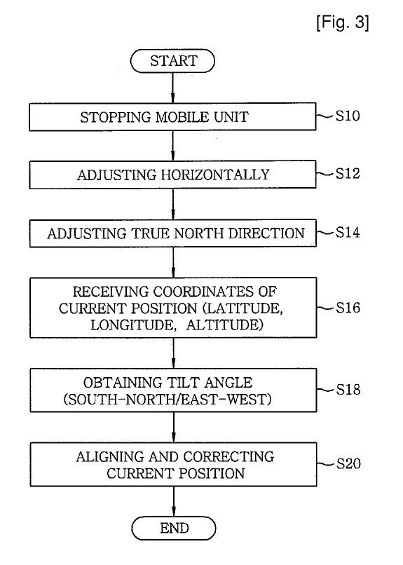

FIG. 3 is a flow chart illustrating the process for tracking coordinates of current position of the mobile apparatus for tracking the satellite in accordance with the present invention.

First, in order to track the position of the satellite while on the move, the position tracking control unit 50 stops and fixes the mobile unit 60 at an arbitrary position (S10).

The CPU 52 of the mobile unit 60 adjusts the mobile unit 60 in horizontal by using the level meter 20 in order to set an initial position of the mobile unit 60 (S12). Such an adjustment in horizontal can be performed by driving the driver 54.

Then, the antenna unit 30 receives the position coordinate signals including the latitude, the longitude, and the altitude of the mobile unit 60 via the GPS receiving unit 10, and the antenna 32 is adjusted in the true north direction (S14). Here, the true north direction of the antenna denotes a direction (azimuth angle 0) that becomes a straight line in the same longitude as center of the antenna with respect to several different latitudes.

For an absolute alignment, the antenna unit 30 receives the coordinates of current position (latitude, longitude and altitude) of the fixed mobile unit 60 via the GPS receiving unit 10, provides them to the ACU 36 (S16), and then obtains the tilt angles in the north-south direction and in the east-west direction of the mobile unit 60 by means of the level meter 20 (S18).

The ACU 36 of the antenna unit 30 transfers the received coordinates of current position of the mobile unit 60 to the position tracking control unit 50. The CPU 52 of the position tracking control unit 50 standardizes the coordinates of current position of the mobile unit 60, and then corrects the coordinates of current position by aligning between the coordinates of current position and the tilt angles, to thereby precisely settle the absolute position coordinates (S20).

Therefore, by adjusting the mobile unit 60 in horizontal, setting reference direction for the azimuth angle of the antenna into the true north direction, and setting the co-ordinates of current position of the mobile unit 60, the satellite position information can be precisely tracked.

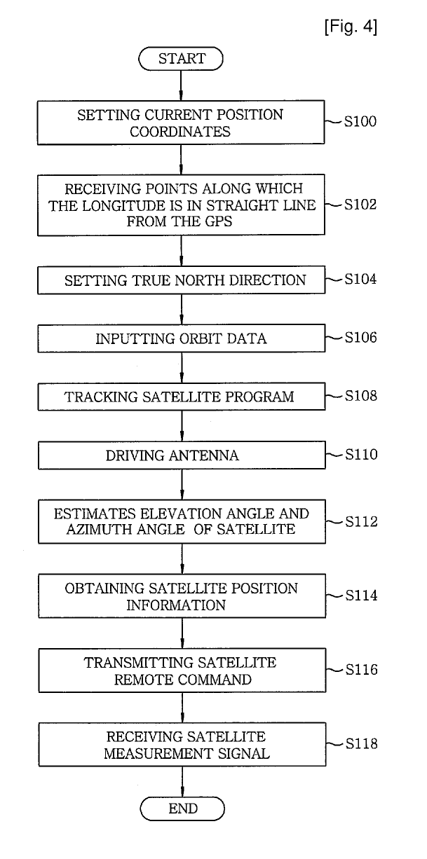

FIG. 4 is a flow chart sequentially showing the process of tracking the satellite by using the mobile apparatus for tracking the satellite in accordance with an embodiment of the present invention.

First, the CPU 52 of the position tracking control unit 50 corrects the coordinates of current position of the mobile unit 60 received from the antenna unit 30 by way of the alignment to thereby set the absolute coordinates of the mobile unit 60 (S100); receives the points along which the longitude is in a straight line from the GPS receiving unit 50; searches the true north direction (the azimuth angle 0) serving as the reference of the azimuth angle; and sets the antenna 32 in the true north direction (S102 to S104).

The input unit 56 of the position tracking control unit 50 receives orbit data of the satellite and transfers the data to the CPU 52 (S106).

The CPU 52 of the position tracking control unit 50 tracks the position of the satellite by executing a program for tracking the position of the satellite based on the received satellite orbit data (S108).

Thereafter, the CPU 52 of the position tracking control unit 50 transfers the tracked satellite position information to the ACU 36 of the antenna unit 30. The ACU 36 of the antenna unit 30 receives the signal from the satellite through the antenna 32 and makes the antenna 32 to move pursuant to the satellite signal from the satellite (S110).

Next, the ACU 36 measures angles at which the antenna 32 is consecutively moved at each preset time interval, e.g., at interval equal to or less than 0.5 seconds, through the antenna driver 34; estimates and obtains the measured angles as an elevation angle and an azimuth angle of the satellite; and transfers them to the CPU 52 of the position tracking control unit 50 (S112).

After that, the CPU 52 of the position tracking control unit 50 determines the orbit of the satellite based on the elevation angle and the azimuth angle of the satellite, and obtains the position information of the satellite according to the orbit of the satellite (S114).

Then, the CPU 52 of the position tracking control unit 50 generates telecommand data for the satellite and transmits the telecommand data to the satellite via the remote transmitting unit 48 and the antenna diplexer 42 of the satellite transmitting and receiving unit 40 (S116).

The satellite transmitting and receiving unit 40 receives the measurement signal from the satellite via the antenna diplexer 42 and the telemetry and ranging signal receiving unit 46 and transfers the same to the CPU 52 of the position tracking control unit 50 so as to be processed. While the invention has been shown and described with respect to the preferred embodiments, it will be understood by those skilled in the art that various changes and modifications may be made without departing from the scope of the invention as defined in the following claims.

1. A mobile apparatus for tracking a satellite, comprising:
a mobile unit;
a GPS receiving unit mounted on the mobile unit that generates position coordinates of the mobile unit;
a level meter mounted on the mobile unit that adjusts the mobile unit in horizontal and obtains a tilt angle of the mobile unit;
an antenna unit mounted on the mobile unit and being adjusted to the true north direction according to the position coordinates; and
position tracking control unit mounted on the mobile unit that temporarily stops the mobile unit when tracking a position of the satellite, adjusts the mobile unit in horizontal by the level meter and aligns the position coordinates and the tile angles to correct current position information of the mobile unit.

2. The device of claim 1, wherein the position tracking control unit controls to drive the antenna unit according to orbit data of the satellite, and measures an elevation angle and azimuth angle of the satellite received from the antenna unit to obtain the position information of the satellite.

3. The apparatus of claim 1, further comprising:
a satellite transmitting and receiving unit that transmits a telecommand signal to the satellite whose position information has been tracked, and receives a measurement signal from the satellite.

4. A method for tracking a satellite by using a mobile apparatus for tracking a satellite, comprising:
fixing the mobile apparatus for tracking a satellite;
setting coordinates of current position of the mobile apparatus for tracking a satellite; and
measuring an elevation angle and an azimuth angle of the satellite using the mobile apparatus for tracking a satellite, thereby obtaining position information of the satellite.

5. The method of claim 4, wherein setting coordinates of current position of the mobile apparatus for tracking a satellite comprising:
adjusting the mobile apparatus for tracking a satellite in horizontal;
adjusting an antenna of the mobile apparatus to true north direction; and
aligning coordinates of current position and a tilt angle of the mobile apparatus for tracking a satellite to correct the coordinates of current position of the mobile apparatus for tracking a satellite.

6. The method of claim 4, wherein obtaining position information of the satellite comprising:
moving the antenna according to the orbit data of the satellite;
measuring the elevation angle and the azimuth angle of the satellite from the moved angle of the antenna at every preset time interval; and
obtaining the position information of the satellite based on the elevation angle and the azimuth angle of the satellite.

7. The method of claim 6, further comprising:
transmitting a telecommand signal to the satellite whose position information has been obtained; and
receiving a measurement signal from the satellite.

8. The method of claim 5, wherein the movable apparatus of tracking a satellite is mounted on a mobile unit.
